(19) United States
(12) Patent Application Publication
(10) Pub. No.: US 2010/0016001 A1
(43) Pub. Date: Jan. 21, 2010

(54) DUAL MODE PHONE AND SECURITY KEY SETTING METHOD

(75) Inventor: SHU-MIN YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/483,230

(22) Filed: Jun. 11, 2009

(30) Foreign Application Priority Data
Jul. 16, 2008 (CN) 200810302756.6

(51) Int. Cl. H04W 4/12; H04M 1/00

(52) U.S. Cl. 455/466; 455/552.1

(57) ABSTRACT

A dual mode phone communicating via a wireless local area network (WLAN) includes a WLAN module, a mobile communication module, and a short message module. The WLAN module communicates via the WLAN and stores a current security key and security mode communicating via the WLAN. The mobile communication module receives a short message via a wireless wide area network, and the short message includes the updated security key and security mode. The short message module receives the short message from the mobile communication module, prompts a user to determine if the current security key and security mode stored in the WLAN module need to be updated, and transmits the updated security key and security mode to the WLAN module if so.

### BACKGROUND

1. Technical Field

The disclosure relates to mobile communication systems, and particularly to a dual mode phone and security key setting method.

2. Description of Related Art

Many public places, such as sports arenas and shopping centers, are equipped with networks for mobile terminal use. Dual mode phones can communicate via wireless local area networks (WLANs) or wireless wide area networks (WWANs). To connect to a WLAN wirelessly, the dual mode phone must first set a security key with an access point (AP) in the WLAN to authenticate itself to the AP for connection to the WLAN.

The security key with the AP is manually set in the dual mode phone, where during the setting process, a plurality of fields requiring special parameters regarding IEEE 802.11 must be filled in, which may not be familiar and difficult for the user. When the dual mode phone roams to another AP, the user of the dual mode phone must set a security key with the new AP once more, increasing inconvenience.

### BRIEF DESCRIPTION OF THE DRAWINGS

FIG. 1 is a schematic diagram of a mobile communication system using a dual mode phone as disclosed.

FIG. 2 is a schematic diagram of a first network access device.

FIG. 3 is a flowchart of a first embodiment of a security key setting method.

FIG. 4 is a flowchart of a second embodiment of a security key setting method of the first network access device of FIG. 2.

FIG. 5 is a flowchart of a third embodiment of a security key setting method of a dual mode phone as disclosed.

FIG. 6 is a flowchart of a fourth embodiment of a security key setting method.

FIG. 7 is a flowchart of a fifth embodiment of a security key setting method.

### DETAILED DESCRIPTION

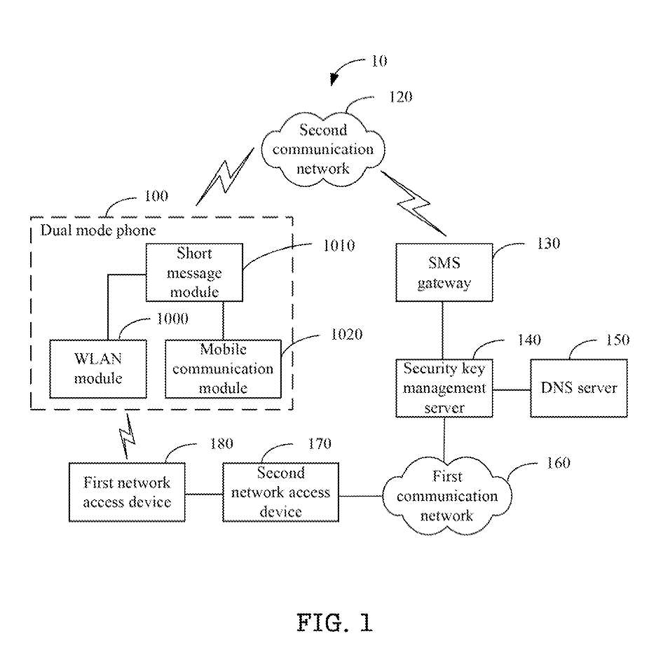

FIG. 1 is a schematic diagram of a mobile communication system 10 using a dual mode phone 100 as disclosed. In one embodiment, the mobile communication system 10 sets a security key between the dual mode phone 100 and at least one first network access device 180 (only one shown), and includes the dual mode phone 100, a short message service (SMS) gateway 130, a security key management server 140, and the first network access device 180.

The first network access device 180 periodically broadcasts a beacon frame, to the dual mode phone 100, the beacon frame including an address of the first network access device 180. In one embodiment, the first network access device 180 is an access point (AP) in a wireless local area network (WLAN), broadcasting a beacon fame every 100 milliseconds (ms). The beacon frame includes a media access control (MAC) address of the first network access device 180.

The dual mode phone 100 wirelessly communicates with the first network access device 180, receives the beacon frame, retrieves the MAC address of the first network access device 180, and transmits the MAC address of the first network access device 180 via a short message. In one embodiment, the dual mode phone 100 includes a WLAN module 1000, a short message module 1010, and a mobile communication module 1020. The WLAN module 1000 receives the beacon frame, and retrieves the MAC address of the first network access device 180 from the received beacon frame. The short message module 1010 retrieves the MAC address of the first network access device 180 from the WLAN module 1000, generates a short message with the MAC address of the first network access device 180, prompts a user to determine if automatic setting of a security key is needed, and transmits the short message with the MAC address of the first network access device 180 to the mobile communication module 1020 upon the condition that the automatic setting of a security key is needed. In the disclosure, the short message module 1010 generates a reminder to prompt the user if automatic setting of a security key is needed, and determines if automatic setting of a security key is needed according to a choice of the user.

The mobile communication module 1020 transmits the short message with the MAC address of the first network access device 180 to the SMS gateway 130. Depending on the embodiment, the mobile communication module 1020 supports Global System for Mobile Communications (GSM), code division multiple access 2000 (CDMA 2000), wideband CDMA (WCDMA), general packet radio service (GPRS), third generation (3G), and/or worldwide interoperability for microwave access (WiMAX).

The MAC address of the first network access device 180 can also be manually input to the short message module 1010 to generate a short message with the MAC address of the first network access device 180.

The SMS gateway 130 receives the short message transmitted by the dual mode phone 100, retrieves the MAC address of the first network access device 180 from the short message, and transmits the MAC address and a phone number of the dual mode phone 100 to the security key management server 140.

The security key management server 140 receives the MAC address of the first network access device 180 and the phone number of the dual mode phone 100 transmitted by the SMS gateway 130, retrieves an identifiable name of the first network access device 180 according to the MAC address, transmits a security key request to the first network access device 180 and receives a security key therefrom according to the retrieved identifiable name, and transmits the security key to the SMS gateway 130. Then the SMS gateway 130 transmits the security key to the dual mode phone 100 via another short message, and the mobile communication module 1020 transmits the other short message with the security key to the short message module 1010 to store the security key in the WLAN module 1000. In one embodiment, the identifiable name of the first network access device 180 may be an Internet protocol (IP) address of the first network access device 180. The security key management server 140 further stores the MAC address and identifiable name of the first network access device 180 and a phone number of corresponding dual mode phone 100 communicating with the first network access device 180.

The mobile communication system 10 further includes a first communication network 160 for connecting the security key management server 140 to the first network access device 180. The first communication network 160 may be an Internet network. The mobile communication system 10 further includes a second network access device 170 for connecting the first network access device 180 to the first communication network 160, and the second network access device 170 may be a modem. In one embodiment, the security key retrieved by the dual mode phone 100 is used for communicating via the first communication network 160.

The mobile communication system 10 further includes a second communication network 120 for connecting the dual mode phone 100 to the SMS gateway 130. The second network 120 may be a wireless wide area network, for example, GSM, CDMA, WCDMA, GPRS, 3G, or WiMAX.

The mobile communication system 10 further includes a domain name system (DNS) server 150. The DNS server 150 is connected to the security key management server 140, and is configured to save addresses and corresponding identifiable names of the first network access device 180. The security key management server 140 searches the DNS server 150 according to the MAC address of the network access device 180 to retrieve the corresponding identifiable name of the network access device 180. In one embodiment, the SMS gateway 130, the security key management server 140, and the DNS server 150 can be integrated into one device.

In one embodiment, the short message sent by the short message module 1010 further includes an address of the dual mode phone 100. The MAC address of the dual mode phone 100 is a MAC address thereof. The SMS gateway 130 further transmits the MAC address of the dual mode phone 100 to the security key management server 140, and the security key management server 140 validates the dual mode phone 100 according to the MAC address of the dual mode phone 100.

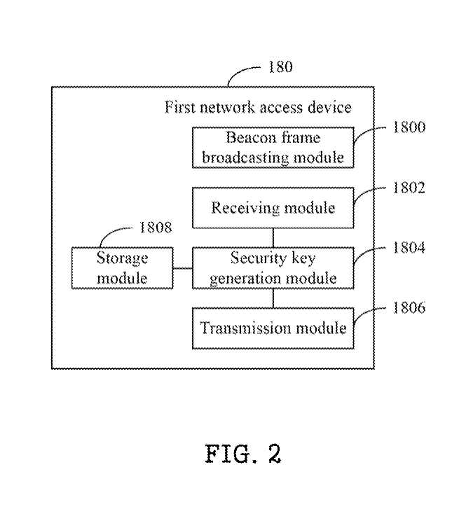

FIG. 2 is a schematic diagram of the first network access device 180. The first network access device 180 includes a beacon frame broadcasting module 1800, a receiving module 1802, a security key generation module 1804, and a transmission module 1806. The beacon frame broadcasting module 1800 periodically broadcasts a beacon frame, and the beacon frame includes the MAC address of the first network access device 180. Thus the dual mode phone 100 can retrieve the MAC address of the first network access device 180, and transmit the MAC address to the security key management server 140 via the SMS gateway 130.

The receiving module 1802 receives the security key request transmitted by the security key management server 140. The security key generation module 1804 generates a security key according to the security key request. In one embodiment, the security key generation module 1804 generates the security key dynamically. The transmission module 1806 transmits the security key to the security key management server 140 to transmit to the dual mode phone 100. In one embodiment, the security key request and the security key are sent via Internet packets. The security key generation module 1804 can also periodically update the security key and a security mode with the dual mode phone 100, and generate a security key updating packet including the updated security key and security mode. The transmission module 1806 also transmits the security key updating packet to the security key management server 140.

The first network access device 180 further includes a storage module 1808 connected to the security key generation module 1804 to save preset security keys. In one embodiment, the security key generation module 1804 selects a security key from the storage module 1808 according to the security key request.

The security key management server 140 further retrieves a phone number of a corresponding dual mode phone 100 according to a source address of the security key updating packet and transmits the updated security key and security mode and the phone number of the corresponding dual mode phone 100 to the SMS gateway 130. The SMS gateway 130 generates a short message with the updated security key and security mode, and transmits the short message with the updated security key and security mode to the corresponding dual mode phone 100. The mobile communication module 1020 of the dual mode phone 100 transmits the short message with the updated security key and security mode to the short message module 1010 to prompt a user to determine if a current security mode and security key need to be updated, and if the current security mode and security key need to be updated, the short message module 1010 transmits the updated security key and security mode to the WLAN module 1000 for storage. Thus, the WLAN module 1000 updates the security key and security mode communicating with the first network access device 180.

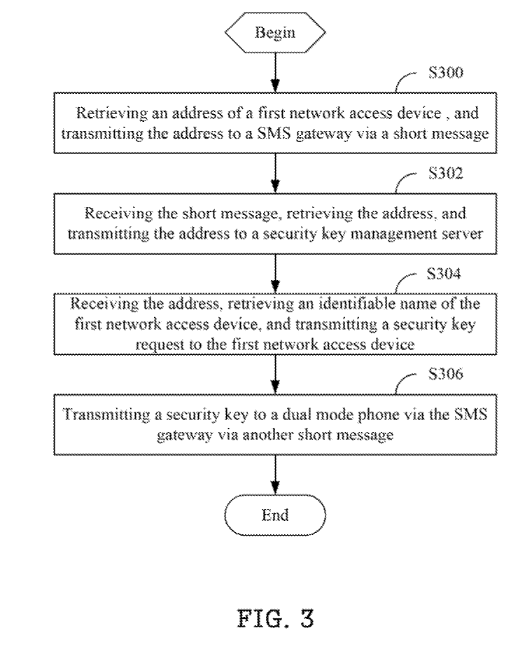

FIG. 3 is a flowchart of a first embodiment of a security key setting method, setting security keys between the first network access device 180 and the WLAN module 100 of the dual mode phone 100. The first network access device 180 periodically broadcasts a beacon frame including an address thereof.

In block S300, the dual mode phone 100 retrieves the MAC address of the first network access device 180, and transmits the MAC address to the SMS gateway 130 via a short message.

In block S302, the SMS gateway 130 receives the short message, retrieves the MAC address of the first network access device 180 from the short message, and transmits the MAC address to the security key management server 140.

In block S304, the security key management server 140 receives the MAC address of the first network access device 180, retrieves an identifiable name of the first network access device 180 according to the MAC address, and transmits a security key request to the first network access device 180 corresponding to the identifiable name. The first network access device 180 receives the security key request, generates and transmits back a security key.

In block S306, the security key management server 140 receives the security key, and transmits the security key to the dual mode phone 100 via the SMS gateway 130 via another short message. Thus, the security key is setting between the dual mode phone 100 and the first network access device 180, and the dual mode phone 100 can communicate with the first network access device 180.

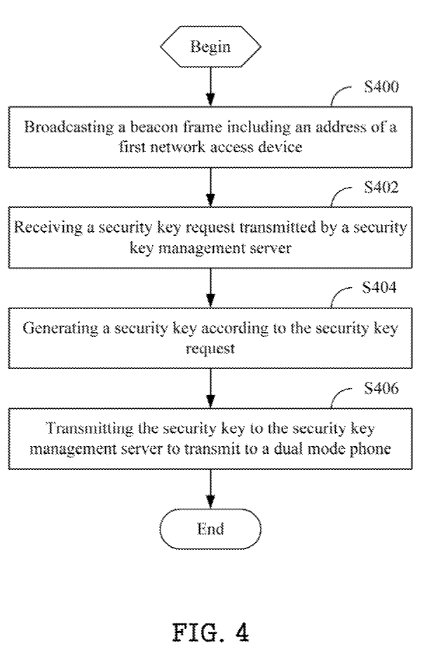

FIG. 4 is a flowchart of a second embodiment of a security key setting method of the first network access device of FIG. 2, in which, in block S400, the beacon frame broadcasting module 1800 of the first network access device 180 broadcasts a beacon frame including the MAC address of the first network access device 180, such that the dual mode phone 100 can retrieve the MAC address and transmit the MAC address to the security key management server 140 via the SMS gateway 130. The security key management server 140 retrieves an identifiable name of the first network access device 180 according to the MAC address, and transmits a security key request to the first network access device 180 corresponding to the identifiable name.

In block S402, the receiving module 1802 receives the security key request transmitted by the security key management server 140.

In block S404, the security key generation module 1804 generates a security key according to the security key request.

In block S406, the transmission module 1806 transmits the security key to the security key management server 140 to finally transmit to the dual mode phone 100.

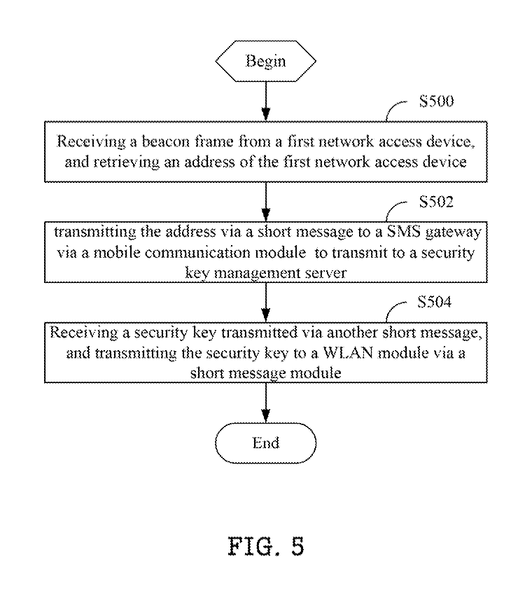

FIG. 5 is a flowchart of a third embodiment of a security key setting method of a dual mode phone as disclosed. In block S500, the WLAN module 1000 of the dual mode phone 100 receives a beacon frame transmitted by the first network access device 180, and retrieves an address of the first network access device 180.

In block S502, the short message module 1010 retrieves the MAC address of the first network access device 180 from the WLAN module 1000, and transmits the MAC address via a short message to the SMS gateway 130 via the mobile communication module 1020 to transmit to the security key management server 140. The security key management server 140 transmits a security key request to the first network access device 180 to retrieve a security key.

In block S504, the mobile communication module 1020 receives the security key transmitted via another short message, and transmits the security key to the WLAN module 1000 via the short message module 1010.

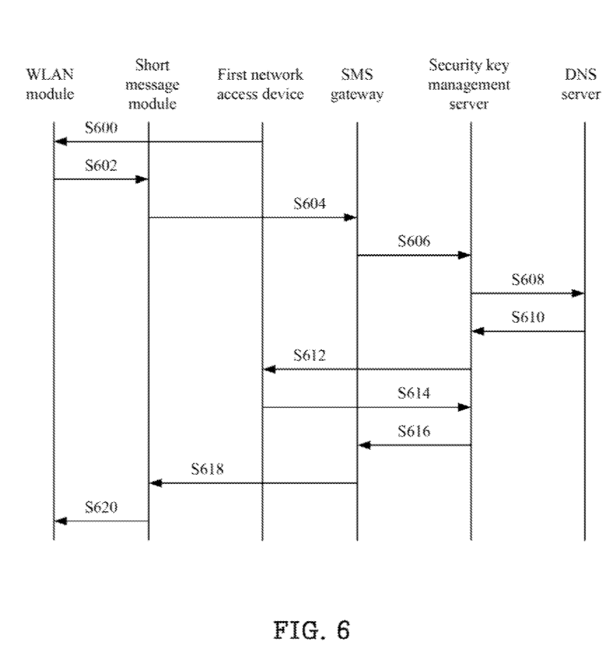

FIG. 6 is a flowchart of a fourth embodiment of a security key setting method. In block S600, the first network access device 180 broadcasts a beacon frame including an address of the first network access device 180. In one embodiment, the MAC address may be a MAC address of the first network access device 180.

In block S602, the WLAN module 1000 receives the beacon frame, retrieves the MAC address of the first network access device 180 from the beacon frame, and transmits the MAC address to the short message module 1010. In one embodiment, the MAC address of the first network access device 180 is input to the short message module 1010.

In block S604, the short message module 1010 receives the MAC address of the first network access device 180, generates a short message with the MAC address, and transmits the short message to the SMS gateway 130 via the mobile communication module 1020.

In block S606, the SMS gateway 130 receives the short message from the dual mode phone 100, retrieves the MAC address of the first network access device 180 from the short message, and transmits the MAC address to the security key management server 140.

In block S608, the security key management server 140 transmits the MAC address of the first network access device 180 to the DNS server 150 to search for an identifiable name of the first network access device 180. In one embodiment, the identifiable name of the first network access device 180 is an IP address of the first network access device 180.

In block S610, the DNS server 150 transmits the identifiable name of the first network access device 180 to the security key management server 140.

In block S612, the security key management server 140 transmits a security key request to the first network access device 180 corresponding to the identifiable name.

In block S614, the first network access device 180 receives the security key request, generates a security key according to the security key request, and transmits the security key to the security key management server 140. In one embodiment, the communications of blocks S608, S610, S612, and S614 are done via Internet packets.

In block S616, the security key management server 140 receives the security key, and transmits the security key to the SMS gateway 130. In one embodiment, the security key management server 140 transmits the security key to the SMS gateway 130 via AT commands.

In block S618, the SMS gateway 130 transmits the security key to the short message module 1010 via another short message and the mobile communication module 1020.

In block S620, the short message module 1010 transmits the security key to WLAN module 1000. Thus, the security key between the dual mode phone 100 and the first network access device 180 is successfully set.

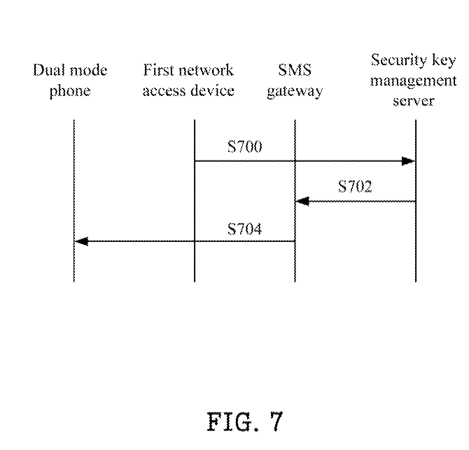

FIG. 7 is a flowchart of a fifth embodiment of a security key setting method. In block S700, the security key generation module 1804 of the first network access device 180 updates a security key and a security mode, and generates a security key updating packet including the updated security key and security mode, and the transmission module 1806 transmits the security key updating packet to the security key management server 140.

In block S702, the security key management server 140 retrieves a phone number of a corresponding dual mode phone 100 according to a source address of the security key updating packet, and transmits the updated security key and security mode and the phone number of the corresponding dual mode phone 100 to the SMS gateway 130

In block S704, the SMS gateway 130 generates a short message with the updated security key and security mode, and transmits the short message with the updated security key and security mode to the mobile communication module 1020 to transmit to the short message module 1010. The short message module 1010 prompts a user to determine if a current security mode and security key stored in the WLAN module 1000 need to be updated, and determines if a current security mode and security key need to be updated according to a choice of the user, and, if so, the short message module 1010 transmits the updated security key and security mode to the WLAN module 1000. Thus, the WLAN module 1000 can communicate with the first network access device 180 via the updated security key and security mode. If the current security mode and security key do not need to be updated, the user can update via the short message module 1010 when there is a need.

The security key between the WLAN module 1000 of the dual mode phone 100 and the first network access device 180 can be automatically set and updated by the short message module 1010 via short messages without additional protocols and programs, thereby decreasing loads of the WLAN module 1000 of the dual mode phone 100.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A dual mode phone for wirelessly communicating with at least one network access device that periodically updates a security key and a security mode for the dual mode phone and generates a security key updating packet comprising the updated security key and security mode, the dual mode phone comprising:
a wireless local area network (WLAN) module to communicate with the at least one network access device and store a current security key and a current security mode communicating with the at least one network access device;
a mobile communication module to receive a short message with the updated security key and security mode from a short message service (SMS) gateway that receives the updated security key and security mode and a telephone number of the dual mode phone from a security key management server, the security key management server storing a media access control (MAC) address and an identifiable name of the at least one network access device and a telephone number of corresponding dual mode phone communicating with the at least one network access device, and retrieving the telephone number of the dual mode phone according to a source address of the security key updating packet from the at least one network access device; and
a short message module to receive the short message with the updated security key and security mode from the mobile communication module, prompt a user of the mobile phone to determine if the current security key and security mode stored in the WLAN module need to be updated, and to transmit the updated security key and security mode to the WLAN module upon the condition that the current security key and security mode needs to be updated.

2. The dual mode phone of claim 1, wherein the WLAN module further receives a beacon frame comprising the MAC address of the at least one network access device periodically broadcasted by the at least one network access device, and retrieves the MAC address of the at least one network access device from the beacon frame.

3. The dual mode phone of claim 2, wherein the short message module further generates another short message with the MAC address of the at least one network access device, prompts the user to determine if automatic setting of a security key is needed, and transmits the other short message with the MAC address of the at least one network access device to the mobile communication module to transmit to the security key management server via the SMS gateway if the automatic setting of a security key is needed.

4. The dual mode phone of claim 1, wherein the short message module generates a reminder to prompt the user to determine if the current security key and security mode stored in the WLAN module needs to be updated.

5. A dual mode phone, communicating via a wireless local area network (WLAN), comprising:
a WLAN module to communicate via the WLAN and store a current security key and security mode of the dual mode phone communicating via the WLAN;
a mobile communication module to receive a short message via a wireless wide area network, wherein the short message comprises the updated security key and security mode; and
a short message module to receive the short message from the mobile communication module, prompt a user to determine if the current security key and security mode stored in the WLAN module need to be updated, and to transmit the updated security key and security mode to the WLAN module upon the condition that the current security key and security mode stored in the WLAN module needs to be updated.

6. The dual mode phone of claim 5, wherein the WLAN module further receives a beacon frame from a network access device in the WLAN, and retrieves a media access control (MAC) address of the network access device from the beacon frame.

7. The dual mode phone of claim 6, wherein the short message module further generates another short message with the MAC address of the network access device, prompts the user to determine if automatic setting of a security key is needed, and transmits the other short message to the mobile communication module to send to the wireless wide area network upon the condition that automatic setting of a security key is needed.

8. The dual mode phone of claim 5, wherein the short message module generates a reminder to prompt the user to determine if the current security key and security mode stored in the WLAN module need to be updated.

9. A security key setting method, used in a dual mode phone, comprising:
receiving a short message via a wireless wide area network, wherein the short message comprises an updated security key and security mode communicating via a wireless local area network (WLAN);
prompting a user to determine if a current security key and security mode need to be updated; and
storing the updated security key and security mode to communicate via the WLAN upon the condition that the current security key and security mode need to be updated.

10. The security key setting method of claim 9, further comprising:
receiving a beacon frame from a network access device in the WLAN, and retrieving a media access control (MAC) address of the network access device;
generating another short message with the MAC address of the network access, and determining if automatic setting of a security key is needed;
transmitting the other short message to the wireless wide area network upon the condition that automatic setting of a security key is needed; and
receiving a security key sent back via a further short message, and storing the security key.

11. The security key setting method of claim 9, wherein the block of prompting a user to determine if a current security key and security mode need to be updated comprises:
generating a reminder to prompt the user to determine if the current security key and security mode need to be updated.
